(19) United States
(12) Patent Application Publication
(10) Pub. No.: US 2017/0221373 A1
(43) Pub. Date: Aug. 3, 2017

(54) EVALUATING RESOLVER SKILLS

(71) Applicant: International Business Machines Corporation, Armonk, NY (US)

(72) Inventors: Gargi Banerjee Dasgupta, Bangalore (IN); Shantanu Ravindra Godbole, Bangalore (IN); Saravanan Krishnan, Vellore (IN); Sethuramalingam Subramaniam, Bangalore (IN)

(21) Appl. No.: 15/013,818

(22) Filed: Feb. 2, 2016

(51) Int. Cl. G09B 7/02

(52) U.S. Cl. CPC G09B 7/02

(57) ABSTRACT

One embodiment provides a method for evaluating resolver skills, the method including: utilizing at least one processor to execute computer code that performs the steps of: obtaining a closed ticket; extracting, from the closed ticket, ticket information; associating, based on the ticket information, the closed ticket with a resolver; identifying, based on the ticket information, at least one performance characteristic associated with the resolver; and updating, based on the performance characteristic, a resolver score. Other aspects are described and claimed.

### BACKGROUND

Customer service is vital for any service industry. The information technology sector is no different. When a customer submits a ticket (e.g., change ticket, incident ticket, problem ticket, etc.) companies are required to respond quickly and efficiently to these requests. Additionally, the ticket resolution process can be extremely specific depending on the type of ticket submitted. Depending on the complexity of a ticket, it may require an extensive amount of time for a subject matter expert to resolve. These unavoidable realities result in the ticket resolution process having the potential to be a high operational cost to a business.

The ticket resolution process typically involves multiple levels (e.g., receiving the ticket, initial investigation, resolution, completion, etc.), and a reduction in cost for any of those levels can be of great importance to any business that relies heavily on information technology service. Thus, the correct identification and resolution of a ticket is vital to a company's bottom line. In order to improve the ticket resolution process, appropriate checks and evaluation procedures need to be in place to monitor and evaluate each resolver (i.e., subject matter expert) and each resolver group.

### BRIEF SUMMARY

In summary, one aspect of the invention provides a method for evaluating resolver skills, the method comprising: utilizing at least one processor to execute computer code that performs the steps of: obtaining a closed ticket; extracting, from the closed ticket, ticket information; associating, based on the ticket information, the closed ticket with a resolver; identifying, based on the ticket information, at least one performance characteristic associated with the resolver; and updating, based on the performance characteristic, a resolver score.

Another aspect of the invention provides an apparatus for evaluating resolver skills, the apparatus comprising: at least one processor; and a computer readable storage medium having computer readable program code embodied therewith and executable by the at least one processor, the computer readable program code comprising: computer readable program code that obtains a closed ticket; computer readable program code that extracts, from the closed ticket, ticket information; computer readable program code that associates, based on the ticket information, the closed ticket with a resolver; computer readable program code that identifies, based on the ticket information, at least one performance characteristic associated with the resolver; and computer readable program code that updates, based on the performance characteristic, a resolver score.

An additional aspect of the invention provides a computer program product for evaluating resolver skills, the computer program product comprising: a computer readable storage medium having computer readable program code embodied therewith, the computer readable program code comprising: computer readable program code that obtains a closed ticket; computer readable program code that extracts, from the closed ticket, ticket information; computer readable program code that associates, based on the ticket information, the closed ticket with a resolver; computer readable program code that identifies, based on the ticket information, at least one performance characteristic associated with the resolver; and computer readable program code that updates, based on the performance characteristic, a resolver score.

A further aspect of the invention provides a method, the method comprising: utilizing at least one processor to execute computer code that performs the steps of: dynamically monitoring domain knowledge and group awareness of an individual resolver, wherein the monitoring collects information from one or more closed tickets; generating a numerical value based on the collected information; and adjusting a cumulative resolver score based on the generated numerical value.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a method for evaluating resolver skills.

FIG. 2 illustrates an example overall resolver score table.

FIG. 3 illustrates an example computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

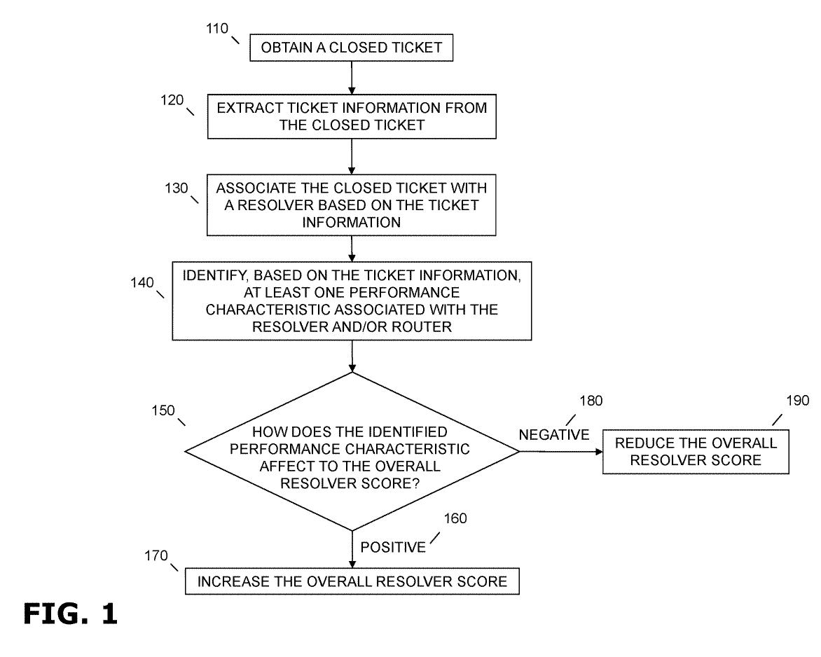

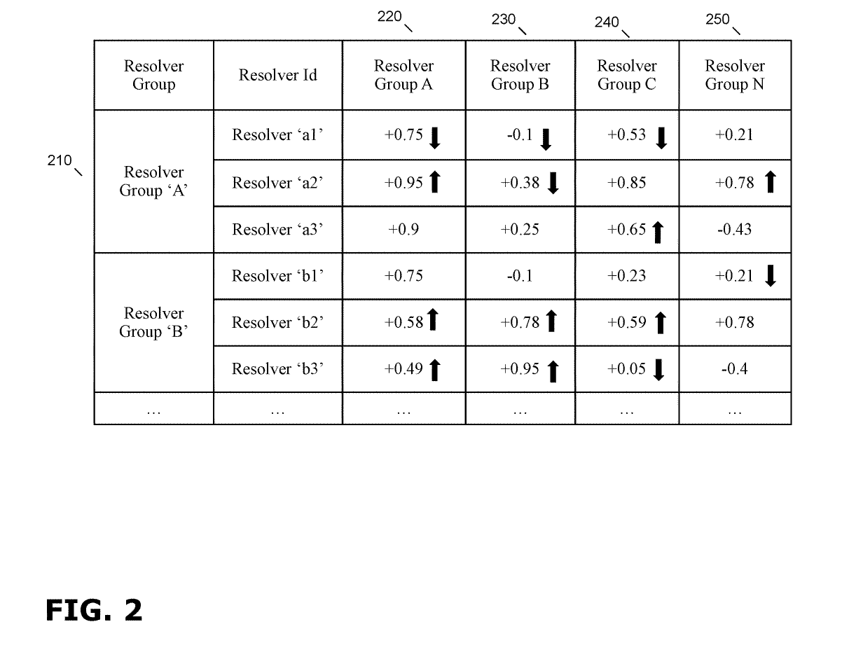

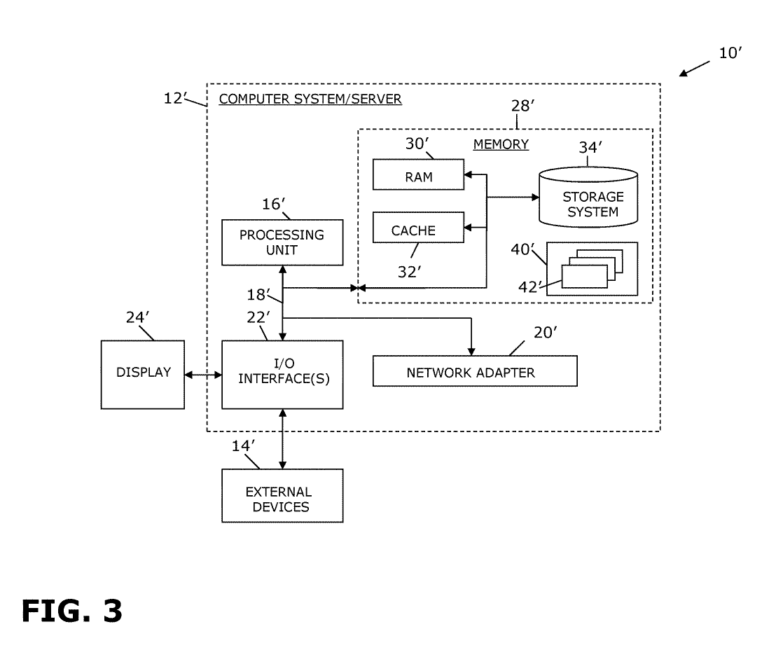

Specific reference will be made here below to the figures. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

As stated herein, ticket resolution is one of the key issues in Information Technology (IT) service delivery. An open ticket is considered resolved, when a first resolver, second resolver, or n-resolver within the chain of action reaches an accepted solution. In order to provide the best service and support, businesses need to maintain and monitor their solution center. A solutions center typically involves multiple groups; each tasked with solving different specialties or granted specific clearance to work on a specific problem. Each group typically consists of a team of resolvers (i.e., the business staff or subject matter experts designated to solve a particular style of problem). Thus, resolvers and their associated expertise play a vital role in ticket resolution. In addition to monitoring resolvers' mastery of a particular subject matter, it is also important to monitor their awareness of other resolver groups (e.g., does a particular resolver have a full understanding of what each group in the solutions center does).

This understanding is vital because, resolvers with poor domain knowledge or limited experience may wrongly transfer a ticket, properly assigned to their group, to a second group which is ill-equipped and/or unable to solve the issue (with its resolvers being weak resolvers). Additionally, a resolver's lack of awareness and understanding of the capabilities of other resolver groups may lead to a ticket being transferred to an incorrect resolver group (with its resolvers being weak routers). This not only increases the overall response time, but it wastes unnecessary resources, namely the time of the additional resolver who identifies the mistake and re-routes or reassigns the ticket to the correct group.

In addition to a resolver misidentifying the appropriate group or specialist, other factors, such as human errors, lack of up-to-date knowledge resources, etc., may lead to wrong ticket transfers. In order to combat this problem, a business needs to be able to identify any weak resolvers or resolver groups. However, this task is currently too cumbersome and difficult for large enterprises. Therefore, any system which can measure and monitor an individual resolver's expertise and group awareness can help in increasing the effectiveness of the workforce management and can lead to better customer satisfaction.

Therefore, one embodiment provides a system which can dynamically measure and monitor both an individual resolver's subject matter expertise (e.g., if they are a “positive” or “weak” resolver) and their awareness and understanding of other groups within the solutions center over time (e.g., if they are a “positive” or “weak” router). In order to achieve this, an embodiment may capture individual resolver domain knowledge from ticket logs and individual resolver awareness on other resolver groups. Based on this captured log information, an embodiment generates a scoring mechanism to measure a resolver's, or a group of resolvers' domain knowledge and awareness of other resolver groups. This allows for a further embodiment to monitor a group of resolvers' performance over time and suggest actions to further improve the process, as discussed herein.

Referring now to FIG. 1, one embodiment may obtain a closed ticket at 110. The term ticket as used herein may refer to a change ticket, trouble ticket, problem ticket, etc.). For example, a user may receive a license error, which prohibits them from logging in to a particular program. Thus, the user may submit a problem ticket which is then issued to a first resolver. This first resolver examines the ticket to determine what type of ticket it is and what may be needed to resolve it. It may be that the first resolver has the requisite skills necessary to resolve the ticket. Alternatively, the first resolver may not have the skills required and may thus need to pass the open ticket along to a different resolver, perhaps in a different group.

Once the open ticket is resolved, either by the first resolver, second resolver, or some resolver within the chain, it is then considered closed. Typically, each step in the resolution process (e.g., the ticket being received at the first resolver, the decision to resolve or reassign the ticket, the rationale behind why the ticket is reassigned or resolved, etc.) is recorded in the work log text or the like. Thus, a closed ticket may contain a great deal of information regarding each step of the resolution process.

Based on this fact, an embodiment may extract, from the closed ticket, ticket information at 120. This ticket information may issue text, work log data, resolution text, etc. and it may take the form of text, images, video, etc. Moreover, this ticket information may be information that was manually entered by a resolver during the resolution process or automatically gathered during the resolution process. For example, a resolver may record their thoughts and rationale during a resolution step, and, in addition, an application (e.g., running in the background) may capture various information during the resolution (e.g., resolver key strokes, specific applications used during the resolution, communication made by the resolver during the resolution, etc.). An embodiment may utilize Natural Language Processing (NPL) during the extracting at 120.

Once the ticket information is extracted at 120, an embodiment associates the closed ticket with a particular resolver at 130. Generally, as discussed herein, each step of the ticket process is tracked. Thus, an embodiment may associate different steps with different individual resolvers. However, each task should be assigned to a specific resolver at a specific step. Thus, an embodiment isolates a particular step of interest and associates that step and action with a particular resolver.

A further embodiment then identifies at least one performance characteristic associated with a particular resolver at one or more steps of the resolution at 140. By way of non-limiting example, the at least one performance characteristic may be one of: resolver technical knowledge and resolver group knowledge. For example, a resolver may have attempted a solution, failed, and subsequently reassigned the ticket to a new resolver. In this example, an embodiment may be interested in the resolver's technical knowledge, thus identifying how successful or how close the attempted solution was (e.g., how far away from the ideal response was the resolver). Moreover, the embodiment may also be interested in the resolver group knowledge (e.g., determining if the resolver should have reassigned the ticket, and if they should have, whether it was reassigned to the best possible group/resolver).

Once a particular performance characteristic is identified, it is rated based on a variety of factors. Continuing from the example above, if it is determined that the failed solution was correct in theory but incorrect in application, or, for example, the solution had 10 steps, 9 of which where carried out correctly, the score associated with the performance characteristic may end up being higher than a typical failed solution score. Additionally, an embodiment may weight the scoring of each performance characteristic based on known factors (e.g., the associated resolver's group, resolver's experience, etc.). For example, if the resolver is part of a group that is tasked with solving network issues, and the resolver fails to solve a network based problem ticket, the negative impact may be greater than if the failure had been related to some other issues (e.g., a hardware issue) outside of the bounds of the resolvers identified expertise.

Once the performance characteristic is identified and scored at 140, an embodiment may adjust the determined score to the overall resolver score (e.g., a historical score based on an aggregate of all previous actions carried out by the resolver at 150). For example, an embodiment may utilize a database to store historical information relating to the resolver, and based on the historical information generate a continuously updated score. This score may then be used during a review or evaluation of a particular resolver or resolver group. The comparison at 150 allows an embodiment to adjust the cumulative resolver score and ensure an accurate score is used during the review/evaluation of a resolver or resolver group.

In one embodiment, it may be determined that the newly identified performance characteristic score is a positive score at 160; thus, it may increase the overall resolver score at 170 by some factor. Alternatively, an embodiment may determine that the newly identified performance characteristic a negative score at 180, and thus may reduce the overall resolver score by some factor at 190. This reduction 190 or increase 170 may be determined based on various factors discussed herein. For example, the performance characteristic is associated with the resolver's group focus, or the total number of previously scored performance characteristics for that resolver (i.e., resolver experience) may be factored into the overall score. Thus, if a resolver has a great deal of experience (e.g., a large number or previously resolved tickets), the impact of one poor performance may not significantly affect the overall score.

In one embodiment, a scoring mechanism may take the resolved tickets in the group (G), and extract the top-n (e.g., n-gram) based feature set (F_{g}) from the issue description, resolution and resolver's work log information. An embodiment may then compute the maximum likelihood that scores for every feature of (f_{g}) of F_{g} based on the following:

$${f}_{g} = \frac{Number of tickets resolved by g containing the feature f}{Total number of tickets resolved by g}$$

For example, let t be the ticket interacted with by a resolver r and resolved by the resolver's own group (g). Then the resolver's (r) knowledge score with respect to the resolver's group (g) may be computed as:

$$r , g ( t ) = \frac{( sign ) \sum features ( {f}_{g} ) identified in t}{Total number of features extracted from t}$$

In the above equation, the “sign” is determined based on whether the resolver is a positive or weak resolver from task 1. The overall knowledge score of a resolver (r) with respect to the resolver group (g) may be summed up as:

$$( r , g ) = \frac{ \begin{matrix}{\sum }_{t}^{T} r , g ( t ) over tickets ( T ) associated \\ {with }^{′} {r}^{′} and resolved {by }^{′} {g}^{′}\end{matrix}}{Size ( T )}$$

Referring now to FIG. 2, as discussed herein, an embodiment may adjust or modify the overall resolver score based on the identified performance characteristic. For example, a first resolver group (e.g., resolver Group A) at 210, may consist of various resolvers (e.g., resolver a1, a2, a3, etc.). Although the resolvers associated with Group A are focused on the concepts required to solve the problems related to Group A, they should also have a solid understanding of the functioning of the additional groups. Thus, an embodiment scores and tracks a resolver's score for multiple groups (e.g., each group within the solution center). Thus, for example, as shown in FIG. 2, the resolver ‘a1’ has a resolver score for Group A at 220, Group B at 230, Group C at 240, and continues out to the total number of groups in the solution center (e.g., Group N at 250).

As discussed herein, the overall values are updated based on the identified performance characteristic. For example, as shown in FIG. 2, resolver ‘a1’ has recently had a reduction in score related to each resolver group, whereas resolver ‘b2’ has had an increase in score for each resolver group. A further embodiment may use these scores to ensure the business is operating efficiently by rewarding those doing excellent work, and training or removing those who do poor work. Thus, an embodiment may identify a particular resolver for promotion based on the updated overall resolver score. For example, resolver ‘a2’ and ‘b3’ both have outstanding scores for their assigned group. Thus, an embodiment may identify both ‘a2’ and ‘b3’ for potential advancement with their respective groups.

Additionally or alternatively, an embodiment may identify a particular resolver for training or termination. By way of example, resolver ‘a1’ and ‘b1’ both have very low scores related to knowledge of Group B. Thus, an embodiment may recommend additional training for both resolvers related to the capability and functions of Group B. Although resolver ‘a1’ is not associated with Group B, it is vital that each resolver have an understanding of each group, because, as discussed herein, each resolver needs the ability to identify and transfer or reassign a ticket to a proper group.

In a further embodiment, a resolver may be identified for relocation based on their resolver score. For example, resolver ‘b1’ has a low score in his associated group (i.e., Group B), and a high score for Group A. Thus, an embodiment may recommend reassigning resolver ‘b1’ into Group A, and potential training related to Group B. In addition to specific resolvers, an embodiment may determine that an entire group needs promotion, training, or relocation. For example, resolver Group A has, as a group, low overall scores related to Group B. Thus, an embodiment may recommend training related to Group B for the entirety of Group A.

Referring now to FIG. 3, a schematic of an example of a computing node is shown. Computing node 10′ is only one example of a suitable computing node and is not intended to suggest any limitation as to the scope of use or functionality of embodiments of the invention described herein. Regardless, computing node 10′ is capable of being implemented and/or performing any of the functionality set forth hereinabove. In accordance with embodiments of the invention, computing node 10′ may be part of a cloud network or could be part of another type of distributed or other network (e.g., it could represent an enterprise server), or could represent a stand-alone node.

In computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for evaluating resolver skills, the method comprising:
utilizing at least one processor to execute computer code that performs the steps of:
obtaining a closed ticket;
extracting, from the closed ticket, ticket information;
associating, based on the ticket information, the closed ticket with a resolver;
identifying, based on the ticket information, at least one performance characteristic associated with the resolver; and
updating, based on the performance characteristic, a resolver score.

2. The method of claim 1, wherein the ticket information is at least one of: issue text, work log data, and resolution text.

3. The method of claim 1, wherein the at least one performance characteristic is selected from the group consisting of: resolver technical knowledge and resolver group knowledge.

4. The method of claim 1, comprising identifying potential resolver relocation based on the updated resolver score.

5. The method of claim 1, comprising identifying potential resolver promotion based on the updated resolver score.

6. The method of claim 1, comprising identifying potential resolver training based on the updated resolver score.

7. The method of claim 1, wherein the at least one performance characteristic is weighted based on a group assigned to the resolver.

8. The method of claim 1, comprising including the updated resolver score into a resolver group score.

9. The method of claim 8, comprising identifying a potential action based on the updated resolver score, the potential action comprising at least one of: group relocation, group training, and group promotion.

10. An apparatus for evaluating resolver skills, the apparatus comprising:
at least one processor; and
a computer readable storage medium having computer readable program code embodied therewith and executable by the at least one processor, the computer readable program code comprising:
computer readable program code that obtains a closed ticket;
computer readable program code that extracts, from the closed ticket, ticket information;
computer readable program code that associates, based on the ticket information, the closed ticket with a resolver;
computer readable program code that identifies, based on the ticket information, at least one performance characteristic associated with the resolver; and
computer readable program code that updates, based on the performance characteristic, a resolver score.

11. A computer program product for evaluating resolver skills, the computer program product comprising:
a computer readable storage medium having computer readable program code embodied therewith, the computer readable program code comprising:
computer readable program code that obtains a closed ticket;
computer readable program code that extracts, from the closed ticket, ticket information;
computer readable program code that associates, based on the ticket information, the closed ticket with a resolver;
computer readable program code that identifies, based on the ticket information, at least one performance characteristic associated with the resolver; and
computer readable program code that updates, based on the performance characteristic, a resolver score.

12. The computer program product of claim 11, wherein the ticket information is at least one of: issue text, work log data, and resolution text.

13. The computer program product of claim 11, wherein the at least one performance characteristic is selected from the group consisting of: resolver technical knowledge and resolver group knowledge.

14. The computer program product of claim 11, comprising computer readable program code that identifies potential resolver relocation based on the updated resolver score.

15. The computer program product of claim 11, comprising computer readable program code that identifies potential resolver promotion based on the updated resolver score.

16. The computer program product of claim 11, comprising computer readable program code that identifies potential resolver training based on the updated resolver score.

17. The computer program product of claim 11, wherein the at least one performance characteristic is weighted based on a group assigned to the resolver.

18. The computer program product of claim 11, comprising computer readable program code that includes the updated resolver score into a resolver group score.

19. The computer program product of claim 18, comprising computer readable program code that identifies a potential action based on the updated resolver score, the potential action comprising at least one of: group relocation, group training, and group promotion.

20. A method, the method comprising:
utilizing at least one processor to execute computer code that performs the steps of:
dynamically monitoring domain knowledge and group awareness of an individual resolver, wherein the monitoring collects information from one or more closed tickets;
generating a numerical value based on the collected information; and
adjusting a cumulative resolver score based on the generated numerical value.
